(19) United States
(12) Patent Application Publication
(10) Pub. No.: US 2023/0155238 A1
(43) Pub. Date: May 18, 2023

(54) BATTERY ACCOMMODATING MEMBER, BATTERY MODULE AND BATTERY FIXING STRUCTURE

(71) Applicant: Merry Electronics(Shenzhen) Co., Ltd., ShenZhen (CN)

(72) Inventors: Ting Hsuan Lin, Taichung (TW); Jen Chieh Cheng, Taichung (TW); Feng-Ping Chang, Taichung (TW)

(73) Assignee: Merry Electronics(Shenzhen) Co., Ltd., ShenZhen (CN)

(21) Appl. No.: 17/572,659

(22) Filed: Jan. 11, 2022

(30) Foreign Application Priority Data
Nov. 18, 2021 (TW) 110143078

(51) Int. Cl. H01M 50/264; H01M 50/204; H01M 50/258

(52) U.S. Cl. CPC H01M 50/264; H01M 50/204; H01M 50/258

(57) ABSTRACT

A battery accommodating member includes a housing, a battery placement portion, an electrical connecting portion, at least one first engaging structure and at least one second engaging structure. The housing has a first surface, a second surface and a plurality of side surfaces. The first surface is opposite to the second surface, and the side surfaces are connected between the first and second surfaces. The battery placement portion is formed in the housing and penetrates from the first surface to the second surface, and a battery is partially accommodated therein. The electrical connecting portion is formed in the first surface, and a conductive sheet is disposed at the electrical connection portion to electrically connect the battery. The first engaging structure is disposed on one side surface, and the second engaging structure is disposed on another side surface. A battery module and a battery fixing structure are also provided.

### CROSS-REFERENCE TO RELATED APPLICATION

This application claims the priority benefit of Taiwan application serial no. 110143078, filed on Nov. 18, 2021. The entirety of the above-mentioned patent application is hereby incorporated by reference herein and made a part of this specification.

### BACKGROUND

### Technical Field

The invention relates to a fixing member, a module and a fixing structure having the fixing member, and especially relates to a battery accommodating member, a battery module and a battery fixing structure having the battery accommodating member.

### Description of Related Art

In energy storage systems, cylindrical batteries are usually fixed through an integrated honeycomb fixing structure. This integrated honeycomb fixing structure is designed according to the size, appearance and internal available space of the product. For different products, different molds need to be developed to produce fixing structures with different specifications, such that the development cost is increased. Besides, the integrated honeycomb fixing structure cannot be reused, which is not conducive to energy saving and carbon reduction.

In the current market, the number of batteries required for energy storage systems is increasing, since the integrated honeycomb fixing structure is only suitable for a single product, the number and placement of the batteries are limited, which in turn affects the diversity of products.

### SUMMARY

The invention provides a battery accommodating member, a battery module and a battery fixing structure, which can lower the cost and can solve the problems of limited number and placement of batteries.

The battery accommodating member of the invention includes a housing, a battery placement portion, an electrical connecting portion, at least one first engaging structure and at least one second engaging structure. The housing has a first surface, a second surface and a plurality of side surfaces. The first surface and the second surface are opposite to each other, and each of the side surfaces are connected between the first surface and the second surface. The battery placement portion is formed in the housing, penetrates from the first surface of the housing to the second surface of the housing, and is adapted for a battery to be partially accommodated therein. The electrical connecting portion is formed in the first surface. At least one conductive sheet is adapted to be disposed at the electrical connecting portion to electrically connect the battery. The at least one first engaging structure is formed on one of the side surfaces. The at least one second engaging structure is formed in another one of the side surfaces.

According to an embodiment of the invention, the at least one first engaging structure protrudes outwards from the one of the side surfaces and includes a first guide curved surface and at least one guide rib, and the at least one second engaging structure extends inwards from the another one of the side surfaces and includes a second guide curved surface and at least one guide groove.

According to an embodiment of the invention, the housing further has at least one guide opening. The guide opening and the second engaging structure are formed in a same side surface and are adjacent to each other, and the guide opening penetrates through the side surface in a first guide direction.

According to an embodiment of the invention, the battery accommodating member further includes at least one first auxiliary connecting portion and at least one second auxiliary connecting portion. The first auxiliary connecting portion is disposed on the one of the side surfaces where the first engaging structure is located, and the second auxiliary connecting portion is disposed on the another one of the side surfaces where the second engaging structure is located.

According to an embodiment of the invention, the first auxiliary connecting portion and the second auxiliary connecting portion are magnets with opposite polarities, respectively.

According to an embodiment of the invention, the housing further has at least one locking hole disposed in the first surface.

The battery module of the invention includes two battery accommodating members and a battery. Each of the battery accommodating members includes a housing, a battery placement portion, an electrical connecting portion, at least one first engaging structure and at least one second engaging structure. The housing has a first surface, a second surface and a plurality of side surfaces. The first surface and the second surface are opposite to each other, and each of the side surfaces are connected between the first surface and the second surface. The battery placement portion is formed in the housing and penetrates from the first surface of the housing to the second surface of the housing. The electrical connecting portion is formed in the first surface, and at least one conductive sheet is adapted to be disposed at the electrical connecting portion. The at least one first engaging structure is formed on one of the side surfaces. The at least one second engaging structure is formed in another one of the side surfaces. An end of the battery is accommodated in the battery placement portion of one of the battery accommodating members, and another end of the battery is accommodated in the battery placement portion of the other one of the battery accommodating members.

According to an embodiment of the invention, the at least one first engaging structure protrudes outwards from the one of the side surfaces and includes a first guide curved surface and at least one guide rib, and the at least one second engaging structure extends inwards from the another one of the side surfaces and includes a second guide curved surface and at least one guide groove.

According to an embodiment of the invention, the housing further has at least one guide opening. The guide opening and the second engaging structure are formed in a same side surface and are adjacent to each other, and the guide opening penetrates through the side surface in a first guide direction.

According to an embodiment of the invention, each of the battery accommodating members further includes at least one first auxiliary connecting portion and at least one second auxiliary connecting portion. The first auxiliary connecting portion is disposed on the one of the side surfaces where the first engaging structure is located, and the second auxiliary connecting portion is disposed on the another one of the side surfaces where the second engaging structure is located.

According to an embodiment of the invention, the first auxiliary connecting portion and the second auxiliary connecting portion are magnets with opposite polarities, respectively.

According to an embodiment of the invention, the housing further has at least one locking hole disposed in the first surface.

The battery fixing structure of the invention includes two battery accommodating members. Each of the battery accommodating members includes a housing, a battery placement portion, an electrical connecting portion, at least one first engaging structure and at least one second engaging structure. The housing has a first surface, a second surface and a plurality of side surfaces. The first surface and the second surface are opposite to each other, and each of the side surfaces are connected between the first surface and the second surface. The battery placement portion is formed in the housing, penetrates from the first surface of the housing to the second surface of the housing, and is adapted for a battery to be partially accommodated therein.

The electrical connecting portion is formed in the first surface. At least one conductive sheet is adapted to be disposed at the electrical connecting portion to electrically connect the battery. The at least one first engaging structure is formed on one of the side surfaces. The at least one second engaging structure is formed on one of the side surfaces. The first engaging structure of one of the battery accommodating members engages the second engaging structure of the other one of the battery accommodating members.

According to an embodiment of the invention, the at least one first engaging structure protrudes outwards from the one of the side surfaces and includes a first guide curved surface and at least one guide rib. The at least one second engaging structure extends inwards from the another one of the side surfaces and includes a second guide curved surface and at least one guide groove. The first engaging structure of the one of the battery accommodating members and the second engaging structure of the other one of the battery accommodating members are engaged with each other. The first guide curved surface of the one of the battery accommodating members contacts the second guide curved surface of the other one of the battery accommodating members. The guide rib of the one of the battery accommodating members engages with the guide groove of the other one of the battery accommodating members.

According to an embodiment of the invention, the housing further has at least one guide opening. The guide opening and the second engaging structure are formed in a same side surface and are adjacent to each other, and the guide opening penetrates through the side surface in a first guide direction. The first engaging structure of the one of the battery accommodating members is adapted to be moved into the housing of the other one of the battery accommodating members in the first guide direction through the guide opening of the other one of the battery accommodating members, and is moved through guiding of the second engaging structure of the other one of the battery accommodating members to engage with the second engaging structure of the other one of the battery accommodating members.

According to an embodiment of the invention, each of the battery accommodating members further includes at least one first auxiliary connecting portion and at least one second auxiliary connecting portion. The first auxiliary connecting portion is disposed on the one of the side surfaces where the first engaging structure is located, and the second auxiliary connecting portion is disposed on the another one of the side surfaces where the second engaging structure is located. The first auxiliary connecting portion of the one of the battery accommodating members is connected to the second auxiliary connecting portion of the other one of the battery accommodating members.

According to an embodiment of the invention, the first auxiliary connecting portion and the second auxiliary connecting portion are magnets with opposite polarities, respectively.

According to an embodiment of the invention, the housing further has at least one locking hole disposed in the first surface.

Based on the above, the battery accommodating member of the invention is provided with the battery placement portion, and a portion of the battery is accommodated inside the battery placement portion. In the battery accommodating member of the invention, the first engaging structure and the second engaging structure are respectively disposed at two different side surfaces of the housing, such that two battery accommodating members is able to be engaged with each other to form a battery fixing structure. That is, the first engaging structure of one of the battery accommodating members can engage with the second engaging structure of another one of the battery accommodating members. In this way, only one battery accommodating member with single specification is needed to infinitely extend different types of products. At the same time, the cost can be reduced, and the number and arrangement of the batteries in the product are not limited. In addition, the battery accommodating member can be reused to facilitate energy saving and carbon reduction.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a perspective view of showing a battery accommodating member of an embodiment of the invention.

FIG. 2 is a perspective view taken from another angle, showing the battery accommodating member in FIG. 1.

FIG. 3 is a sectional schematic view showing a battery module of an embodiment of the invention.

FIG. 4 is a top sectional schematic view showing a plurality of assembled battery modules in FIG. 3 applied to an electronic device.

FIG. 5 is a sectional schematic view showing that two battery accommodating members of a battery fixing structure of an embodiment of the invention are aligned.

FIG. 6 is a sectional schematic view showing that one of the battery accommodating members in FIG. 5 is moved to another one of the battery accommodating members.

FIG. 7 is a sectional schematic view showing that the two battery accommodating members in FIG. 5 are engaged with each other.

FIG. 8 is a bottom view of the two battery accommodating members in FIG. 5.

### DESCRIPTION OF THE EMBODIMENTS

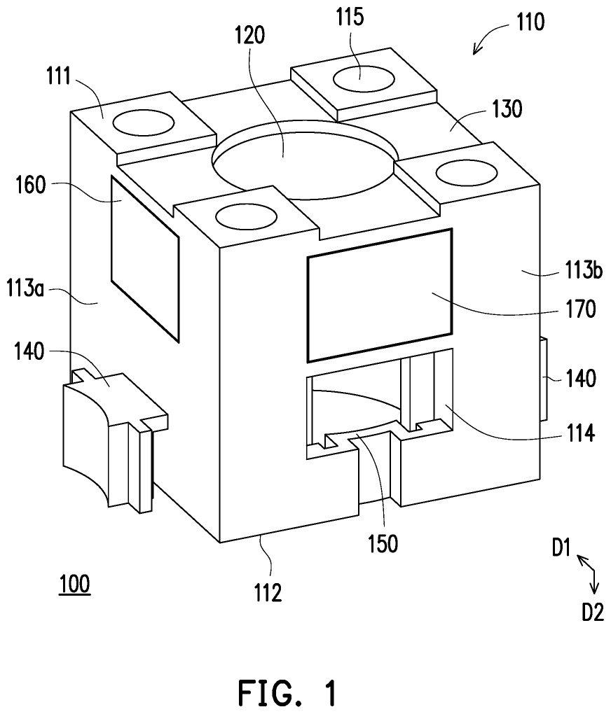

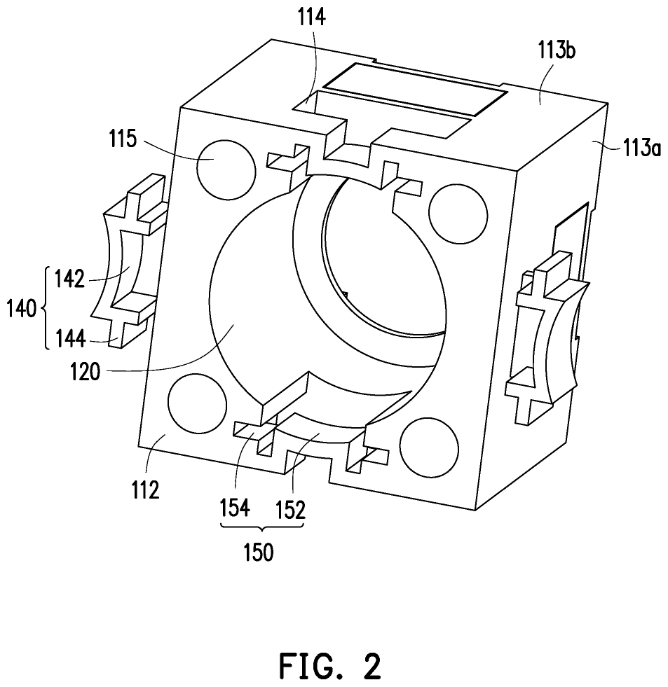

FIG. 1 is a perspective view of showing a battery accommodating member of an embodiment of the invention. FIG. 2 is a perspective view taken from another angle, showing the battery accommodating member in FIG. 1. Please refer to FIG. 1 and FIG. 2, a battery accommodating member 100 of the embodiment includes a housing 110, a battery placement portion 120, an electrical connecting portion 130, at least one first engaging structure 140 and at least one second engaging structure 150.

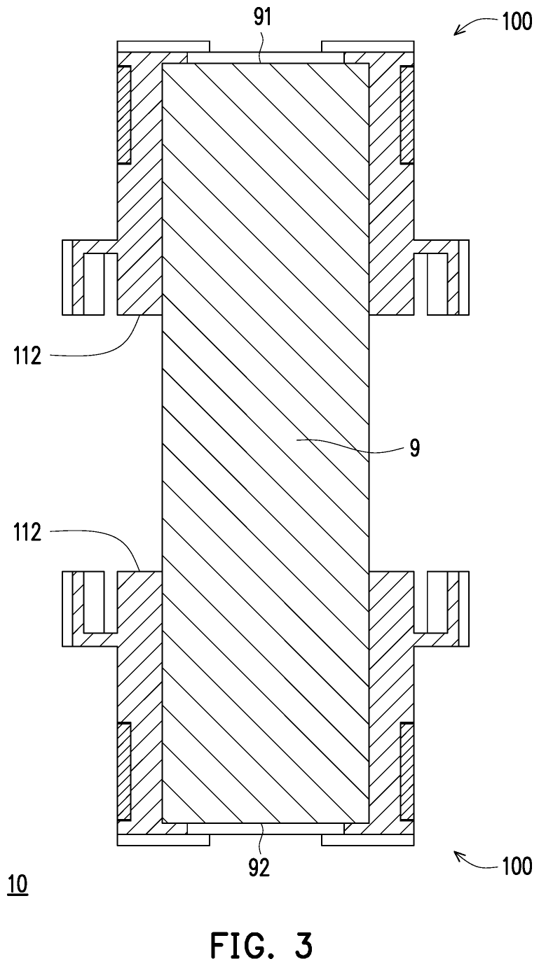

In this embodiment, the housing 110 has a first surface 111, a second surface 112 and a plurality of side surfaces 113a, 113b. To be specific, as shown in FIG. 1 and FIG. 2, the housing 110 is a rectangle. The first surface 111 and the second surface 112 are opposite to each other, the side surface 113a is adjacent to the side surface 113b, and the side surfaces 113a, 113b are connected between the first surface 111 and the second surface 112. The battery placement portion 120 is formed in the housing 110, and the battery placement portion 120 is specifically a through hole, which penetrates from the first surface 111 of the housing 110 to the second surface 112 of the housing 110. The battery placement portion 120 is configured for a battery 9 (labelled in FIG. 3) to be at least partially accommodated therein. The electrical connecting portion 130 is formed in the first surface 111, and at least one conductive sheet is disposed in the electrical connecting portion 130 to electrically connect the battery.

In this embodiment, the battery accommodating member 100 includes two first engaging structures 140 and two second engaging structures 150, but the number of the first engaging structures 140 and the number of the second engaging structures 150 are not limited in the invention. In this embodiment, the two first engaging structures 140 are symmetrical to each other and respectively formed on two opposite side surfaces 113a, and the two second engaging structures 150 symmetrical to each other and are respectively formed on two opposite side surfaces 113b, but the invention is not limited thereto. In other embodiments, two first engaging structures may be arranged in asymmetrical manner and respectively formed on two adjacent side surfaces, and two second engaging structures may be arranged in asymmetrical manner and respectively formed on two adjacent side surfaces.

Please refer to FIG. 2, the first engaging structure 140 protrudes outwards from the side surface 113a and includes a first guide curved surface 142 (i.e., a convex surface) and at least one guide rib 144. The second engaging structure 150 extends inwards from the side surface 113b and includes a second guide curved surface 152 (i.e., a concave surface) and at least one guide groove 154. In this embodiment, there are two guide ribs 144 and two guide grooves 154, but the invention is not limited thereto. In detail, the first engaging structure 140 and the second engaging structure 150 have corresponding shapes, the two guide ribs 144 are respectively disposed at two sides of the first guide curved surface 142, and the two guide grooves 154 are respectively disposed at two sides of the second guide curved surface 152.

In this embodiment, the housing 110 further has at least one guide opening 114. The guide opening 114 and the second engaging structure 150 are formed in the same side surface 113b and are adjacent to each other. The guide opening 114 extends in a first guide direction D1 and penetrates through the housing 110 from the side surface 113b. The guide grooves 154 of the second engaging structure 150 extend in the housing 110 in a second guide direction D2 perpendicular to the first guide direction D1. The guide grooves 154, the guide opening 114 and the battery placement portion 120 are in communication with each other. Besides, the housing 110 in this embodiment further has at least one locking hole 115. The locking hole 115 penetrates through the housing 110 from the first surface 111 to the second surface 112.

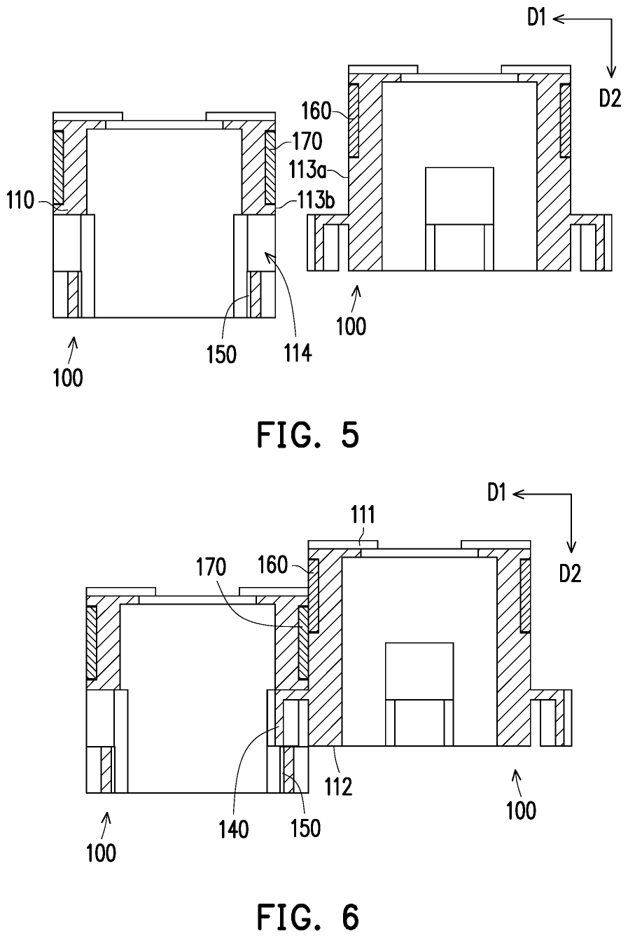

The battery accommodating member 100 further includes at least one first auxiliary connecting portion 160 and at least one second auxiliary connecting portion 170 (as shown in FIG. 5). In this embodiment, there are two first auxiliary connecting portions 160 and two second auxiliary connecting portions 170, but the invention is not limited by the numbers of the first auxiliary connecting portions 160 and the second auxiliary connecting portions 170. The first auxiliary connecting portions 160 are respectively disposed at the side surfaces 113a where the first engaging structures 140 are located. The second auxiliary connecting portions 170 are respectively disposed at the side surfaces 113b where the second engaging structures 150 are located. The first auxiliary connecting portion 160 and the second auxiliary connecting portion 170 are respectively magnets with opposite polarities.

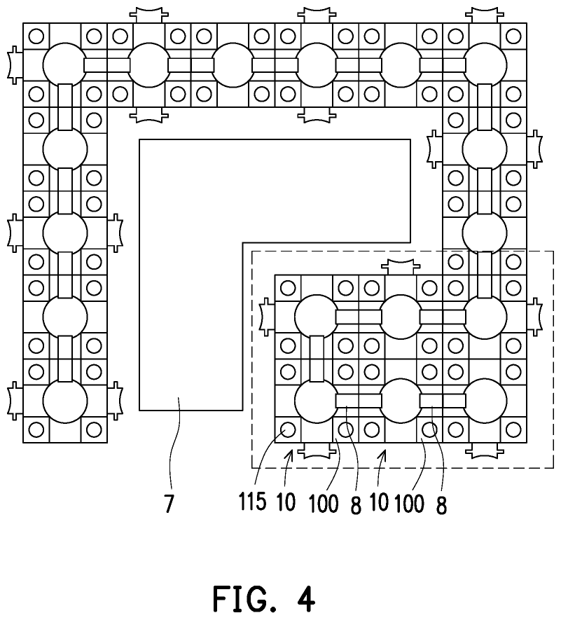

FIG. 3 is a sectional schematic view showing a battery module of an embodiment of the invention. FIG. 4 is a top sectional schematic view showing a plurality of assembled battery modules in FIG. 3 applied to an electronic device. Please refer to FIG. 3 and FIG. 4, in this embodiment, a battery module 120 includes two battery accommodating members 100 and a battery 9. The two battery accommodating members 100 are respectively disposed at two ends of the battery 9. An end 91 of the battery 9 is accommodated in one of the battery accommodating members 100, and another end 92 of the battery 9 is accommodated in the other one of the battery accommodating members 100. By the abovementioned configuration, a middle portion of the battery 9 is exposed, thus heat-dissipation is facilitated. As shown in FIG. 3, the battery 9 is inserted into each battery placement portion 120 from the second surface 112 of each battery accommodating members 100. The conductive sheet 8 (as labelled in FIG. 4) is disposed at the electrical connecting portion 130 to electrically connect the battery 9. For example, multiple fixing modules 10 shown in FIG. 4 may be applied to an electrical device, and these fixing modules 10 are connected to each other through the battery accommodating members 100 and surround a circuit board 7. Each locking hole 115 is configured to secure the fixing modules 10 on components (i.e., housing or substrate and son on, the invention is not limited thereto) of the electronic device.

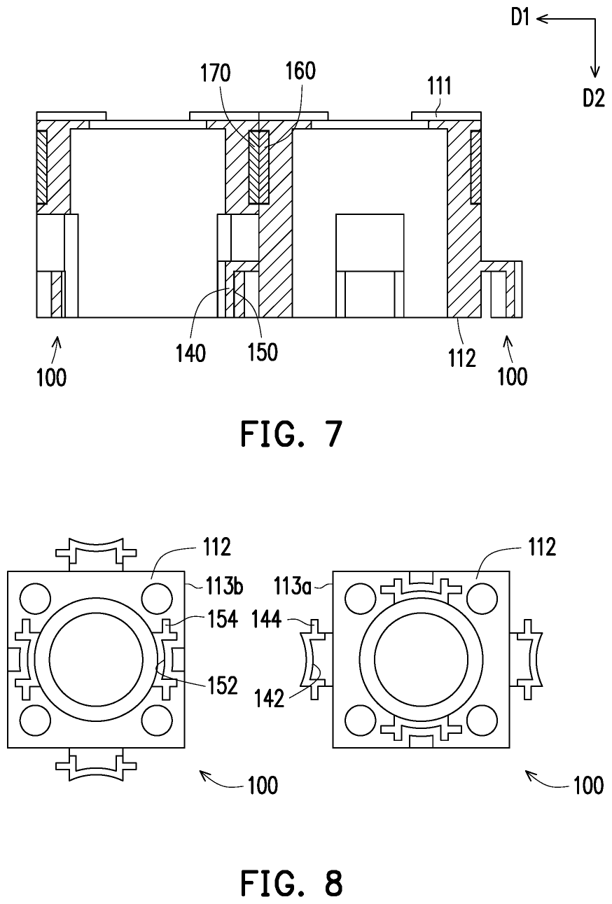

FIG. 5 is a sectional schematic view showing that two battery accommodating members of a battery fixing structure of an embodiment of the invention are aligned. FIG. 6 is a sectional schematic view showing that one of the battery accommodating members in FIG. 5 is moved to another one of the battery accommodating members. FIG. 7 is a sectional schematic view showing that the two battery accommodating members in FIG. 5 are engaged with each other. FIG. 8 is a bottom view of the two battery accommodating members in FIG. 5. Please refer to FIG. 5 to FIG. 8, a battery fixing structure of the invention includes two battery accommodating members 100. The first engaging structure 140 of one of the battery accommodating members 100 engages with the second engaging structure 150 of the other one of the battery accommodating members 100. In this way, only one battery accommodating member 100 with single specification is needed to connect multiple batteries, this saves the cost of mold opening and is conducive to energy saving and carbon reduction. Also, the battery accommodating member with single specification can be arranged according to internal available space of different products, such that the number of the batteries is not limited, so as to improve the diversity of products.

Detailed explanation of assembling of the two battery accommodating members 100 are described in the following. When intending to assemble the two battery accommodating members 100, first, please refer to FIG. 5 and FIG. 6, the first engaging structure 140 of one of the battery accommodating members 100 is aligned to the guide opening 114 of the other one of the battery accommodating members 100, such that the first engaging structure 140 enter the housing 110 of the other one of the battery accommodating members 100 through the guide opening 114 of the other one of the battery accommodating members 100 in the first guide direction D1. At this time, the first auxiliary connecting portion 160 of the one of the battery accommodating members 100 and the second auxiliary connecting portion 170 of the other one of the battery accommodating members 100 are magnetically attached in partial. Then, a force is exerted in the second guide direction D2 to press the first surface 111 of the one of the battery accommodating members 100, such that the first engaging structure 140 is moved in the second guide direction D2 through guiding of the second engaging structure 150, and finally the first engaging structure 140 engages with the second engaging structure 150, as shown in FIG. 7. At this time, the first auxiliary connecting portion 160 and the second auxiliary connecting portion 170 are magnetically attached to each other completely, thus the first engaging structure 140 is prevented from being separated from the second engaging structure 150. Furthermore, in the process of pressing the battery accommodating member 100, since the contact area between the first auxiliary connecting portion 160 and the second auxiliary connecting portion 170 increases, the magnetic attraction force gradually increases, so that the first engaging structure 140 is facilitated to automatically engage with the second engaging structure 150.

In order to clearly show the engagement relationship between the first engaging structure 140 of one battery accommodating member 100 and the second engaging structure 150 of the other battery accommodating member 100, FIG. 8 schematically shows two aligned battery accommodating members 100 separately. Please simultaneously refer to FIG. 7 and FIG. 8, the first engaging structure 140 and the second structure 150 have complementary shapes and contours. When one battery accommodating member 100 and the other battery accommodating member 100 engage with each other, the first guide curved surface 142 of the one battery accommodating member 100 contact the second guide curved surface 152 of the other battery accommodating member 100, and the guide ribs 144 of the one battery accommodating member 100 engage with the guide grooves 154 of the other battery accommodating member 100.

When intending to separate the two battery accommodating members 100, first, a force is exerted to the second surface 112 of one battery accommodating member 100, that is, the one battery accommodating member 100 is pressed in a direction opposite to the second guide direction D2, so as to disengage the first engaging structure 140 of the one battery accommodating member 100 from the second engaging structure 150 of the other battery accommodating member 100. At this time, the first engaging structure 140 is located at the position shown in FIG. 6, a magnetic attraction area between the first auxiliary connecting portion 160 and the second auxiliary connecting portion 170 is reduced such that a user can move the first engaging structure 140 out of the guide opening of the other battery accommodating member 100 in a direction opposite to the first guide direction D1.

It is worth mentioning that, since the first engaging structure 140 enters the housing 110 in the first guide direction D1 and then moves in the second guide direction D2 to engage with the second engaging structure 150, when the first engaging structure 140 and the second engaging structure 150 are engaged, the first engaging structure 140 needs to move in the direction opposite to the second guide direction D2 to a position aligned to the guide opening 114, before the first engaging structure 140 can disengage from the second engaging structure 150 in the direction opposite to the first guide direction D1. Therefore, it is able to prevent the first engaging structure 140 and the second engaging structure 150 from being unintendedly separated from each other, thereby achieving a good securing effect.

Moreover, please refer to six (three columns and two rows) battery accommodating members 100 combined together surrounded by the dashed line on lower right side in FIG. 4. For each battery accommodating member 100 in the area surrounded by the dashed line, at least one first engaging structure 140 and at least one second engaging structure 150 are simultaneously in an engaged state, when intending to separate these battery accommodating members 100 shown in the area surrounded by the dashed line, it is necessary to slide the two rows of the battery accommodating members 100 at the same time to disengage the corresponding first engaging structures and second engaging structures from each other, and afterwards, to perform disengagement one to one. In other words, when the number of battery accommodating members 100 is increased, for example, multiple battery accommodating members 100 are engaged with each other in a matrix shape including multiple columns or rows, the battery accommodating member 100 cannot be easily disassembled, thereby achieving an improved security effect.

Based on the above, in the battery accommodating member of the invention, the first engaging structure and the second structure are disposed at different side surfaces of the housing, such that the first engaging structure of one battery accommodating member is able to engage with the second engaging structure of the other battery accommodating member, so as to form the battery fixing structure. In this way, only one battery accommodating member with single specification is needed to infinitely extend different products with different configurations, this saves the cost of mold opening and is conducive to energy saving and carbon reduction. Also, the battery accommodating member with single specification can achieve diverse arrangement according to internal available space of different products, thus the number of the batteries in the products is not limited.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A battery accommodating member, comprising:
a housing, having a first surface, a second surface and a plurality of side surfaces, wherein the first surface and the second surface are opposite to each other, each of the side surfaces are connected between the first surface and the second surface;
a battery placement portion, formed in the housing, penetrating from the first surface of the housing to the second surface of the housing, and adapted for a battery to be partially accommodated therein;
an electrical connecting portion, formed in the first surface, at least one conductive sheet being adapted to be disposed at the electrical connecting portion to electrically connect the battery;
at least one first engaging structure, formed on one of the side surfaces; and
at least one second engaging structure, formed in another one of the side surfaces.

2. The battery accommodating member according to claim 1, wherein the at least one first engaging structure protrudes outwards from the one of the side surfaces and includes a first guide curved surface and at least one guide rib, and the at least one second engaging structure extends inwards from the another one of the side surfaces and includes a second guide curved surface and at least one guide groove.

3. The battery accommodating member according to claim 1, wherein the housing further has at least one guide opening, the guide opening and the second engaging structure are formed in a same side surface and are adjacent to each other, and the guide opening penetrates through the side surface in a first guide direction.

4. The battery accommodating member according to claim 1, further comprising at least one first auxiliary connecting portion and at least one second auxiliary connecting portion, wherein the first auxiliary connecting portion is disposed on the one of the side surfaces where the first engaging structure is located, the second auxiliary connecting portion is disposed on the another one of the side surfaces where the second engaging structure is located.

5. The battery accommodating member according to claim 4, wherein the first auxiliary connecting portion and the second auxiliary connecting portion are magnets with opposite polarities, respectively.

6. The battery accommodating member according to claim 1, wherein the housing further has at least one locking hole disposed in the first surface.

7. A battery module, comprising:
two battery accommodating members, each of which comprises:
a housing, having a first surface, a second surface and a plurality of side surfaces, wherein the first surface and the second surface are opposite to each other, each of the side surfaces are connected between the first surface and the second surface;
a battery placement portion, formed in the housing, and penetrating from the first surface of the housing to the second surface of the housing;
an electrical connecting portion, formed in the first surface, at least one conductive sheet being adapted to be disposed at the electrical connecting portion;
at least one first engaging structure, formed on one of the side surfaces; and
at least one second engaging structure, formed in another one of the side surfaces,
a battery, wherein an end of the battery is accommodated in the battery placement portion of one of the battery accommodating members, another end of the battery is accommodated in the battery placement portion of the other one of the battery accommodating members.

8. The battery module according to claim 7, wherein the at least one first engaging structure protrudes outwards from the one of the side surfaces and includes a first guide curved surface and at least one guide rib, and the at least one second engaging structure extends inwards from the another one of the side surfaces and includes a second guide curved surface and at least one guide groove.

9. The battery module according to claim 7, wherein the housing further has at least one guide opening, the guide opening and the second engaging structure are formed in a same side surface and are adjacent to each other, and the guide opening penetrates through the side surface in a first guide direction.

10. The battery module according to claim 7, wherein each of the battery accommodating members further comprises at least one first auxiliary connecting portion and at least one second auxiliary connecting portion, wherein the first auxiliary connecting portion is disposed on the one of the side surfaces where the first engaging structure is located, the second auxiliary connecting portion is disposed on the another one of the side surfaces where the second engaging structure is located.

11. The battery module according to claim 10, wherein the first auxiliary connecting portion and the second auxiliary connecting portion are magnets with opposite polarities, respectively.

12. The battery module according to claim 7, wherein the housing further has at least one locking hole disposed in the first surface.

13. A battery fixing structure, comprising:
two battery accommodating members, each of which comprises:
a housing, having a first surface, a second surface and a plurality of side surfaces, wherein the first surface and the second surface are opposite to each other, each of the side surfaces are connected between the first surface and the second surface;
a battery placement portion, formed in the housing, penetrating from the first surface of the housing to the second surface of the housing, and adapted for a battery to be partially accommodated therein;
an electrical connecting portion, formed in the first surface, at least one conductive sheet being adapted to be disposed at the electrical connecting portion to electrically connect the battery;
at least one first engaging structure, formed on one of the side surfaces; and
at least one second engaging structure, formed in another one of the side surfaces,
wherein the first engaging structure of one of the battery accommodating members engages the second engaging structure of the other one of the battery accommodating members.

14. The battery fixing structure according to claim 13, wherein the at least one first engaging structure protrudes outwards from the one of the side surfaces and includes a first guide curved surface and at least one guide rib, the at least one second engaging structure extends inwards from the another one of the side surfaces and includes a second guide curved surface and at least one guide groove, the first engaging structure of the one of the battery accommodating members and the second engaging structure of the other one of the battery accommodating members are engaged with each other, the first guide curved surface of the one of the battery accommodating members contacts the second guide curved surface of the other one of the battery accommodating members, and the guide rib of the one of the battery accommodating members engages with the guide groove of the other one of the battery accommodating members.

15. The battery fixing structure according to claim 13, wherein the housing further has at least one guide opening, the guide opening and the second engaging structure are formed in a same side surface and are adjacent to each other, and the guide opening penetrates through the side surface in a first guide direction,
the first engaging structure of the one of the battery accommodating members is adapted to be moved into the housing of the other one of the battery accommodating members in the first guide direction through the guide opening of the other one of the battery accommodating members, and is moved through guiding of the second engaging structure of the other one of the battery accommodating members to engage with the second engaging structure of the other one of the battery accommodating members.

16. The battery fixing structure according to claim 13, wherein each of the battery accommodating members further comprises at least one first auxiliary connecting portion and at least one second auxiliary connecting portion, wherein the first auxiliary connecting portion is disposed on the one of the side surfaces where the first engaging structure is located, the second auxiliary connecting portion is disposed on the another one of the side surfaces where the second engaging structure is located,
the first auxiliary connecting portion of the one of the battery accommodating members is connected to the second auxiliary connecting portion of the other one of the battery accommodating members.

17. The battery fixing structure according to claim 16, wherein the first auxiliary connecting portion and the second auxiliary connecting portion are magnets with opposite polarities, respectively.

18. The battery fixing structure according to claim 13, wherein the housing further has at least one locking hole disposed in the first surface.
